(19) United States
(12) Patent Application Publication
(10) Pub. No.: US 2023/0359154 A1
(43) Pub. Date: Nov. 9, 2023

(54) METHOD AND CONTROL DEVICE FOR CONTROLLING A MACHINE

(71) Applicant: Siemens Aktiengesellschaft, München (DE)

(72) Inventors: Phillip Swazinna, Neufahrn (DE); Steffen Udluft, Eichenau (DE)

(21) Appl. No.: 18/141,529

(22) Filed: May 1, 2023

(30) Foreign Application Priority Data
May 5, 2022 (EP) 22171748.1

(51) Int. Cl. G05B 13/04; G05B 13/02

(52) U.S. Cl. CPC G05B 13/0265; G05B 13/048

(57) ABSTRACT

Training data sets which are obtained by controlling the machine by different control systems are read in, the training data sets each including a state data set and an action data set. Furthermore, a performance evaluator is provided and determines, for a control agent, a performance for controlling the machine by the control agent. A control-system-specific control agent for the different control systems is respectively trained to reproduce an action data set on the basis of a state data set. In addition, a respective environment is delimited on the basis of a distance dimension in a parameter space of the control-system-specific control agents. Test control agents, for each of which a performance value is determined by the performance evaluator, are then generated within the environments. Depending on the determined performance values, a performance-optimizing control agent is finally selected from the test control agents and is used to control the machine.

### CROSS-REFERENCE TO RELATED APPLICATIONS

This application claims priority to EP Application No. 22171748.1, having a filing date of May 05, 2022, the entire contents of which are hereby incorporated by reference.

### FIELD OF TECHNOLOGY

The following relates to a method and control for controlling a machine.

### BACKGROUND

Data-driven machine learning methods are being increasingly used to control complex machines, for example robots, motors, production plants, factories, machine tools, milling machines, gas turbines, wind turbines, steam turbines, chemical reactors, cooling plants or heating plants. In this case, artificial neural networks, in particular, are trained, using reinforcement learning methods, to generate, for a respective state of the machine, a state-specific control action for controlling the machine, which control action optimizes a performance of the machine. Such a control agent optimized to control a machine is often also referred to as a policy or as an agent for short.

Large amounts of operating data relating to the machine to be controlled are generally needed as training data in order to successfully optimize a control agent. In this case, the training data should cover the possible operating states and other operating conditions of the machine as representatively as possible.

In many cases, such training data are available in the form of databases in which operating data recorded on the machine are stored. Such stored training data are often also referred to as batch training data or offline training data. Experience shows that training success generally depends on the extent to which the possible operating conditions of the machine are covered by the available training data. Accordingly, it can be expected that trained control agents would behave unfavorably in those operating states for which only few training data items were available.

In order to improve the control behavior in regions of a state space that are not well covered by training data, the publication “Deployment-Efficient Reinforcement Learning via Model-Based Offline Optimization” by Tatsuya Matsushima, Hiroki Furuta, Yutaka Matsuo, Ofir Nachum and Shixiang Gu at https://arxiv.org/abs/2006.03647 (retrieved on Apr. 14, 2022) proposes a recursive learning method. However, this method provides stochastic policies which, for the same operating state, can sometimes output very different control actions which cannot be predicted with certainty. In this manner, although the state space can be explored efficiently, such stochastic policies on a large number of machines are not permissible insofar as they cannot be validated with certainty in advance.

A further method for improving a control behavior of control agents is known from the online publication “Overcoming Model Bias for Robust Offline Deep Reinforcement Learning” by Phillip Swazinna, Steffen Udluft and Thomas Runkler at https://arxiv.org/pdf/2008.05533 (retrieved on Apr. 14, 2022). However, the resulting policies often cannot be clearly evaluated or validated in this method either.

### SUMMARY

An aspect relates to a method and a control device for controlling a machine which allow more efficient training even of non-stochastic control agents.

In order to control a machine by a control agent, training data sets which are obtained by controlling the machine by different control systems and are assigned to a respective control system are read in. In this case, the term control should also be understood as meaning regulation of the machine. The training data sets each comprise a state data set specifying a state of the machine and an action data set specifying a control action. Furthermore, a performance evaluator is provided and determines, for a control agent, a performance for controlling the machine by this control agent. According to embodiments of the invention, a control-system-specific control agent for the different control systems is respectively trained, on the basis of the training data sets assigned to the respective control system, to reproduce an action data set on the basis of a state data set. In addition, a respective environment around the trained control-system-specific control agents is delimited on the basis of distance dimension in a parameter space of the control-system-specific control agents. A multiplicity of test control agents, for each of which a performance value is determined by the performance evaluator, are then generated within the environments. Depending on the determined performance values, a performance-optimizing control agent is finally selected from the test control agents and is used to control the machine.

In order to carry out the method according to embodiments of the invention, provision is made for a corresponding control device, a computer program product (non-transitory computer readable storage medium having instructions, which when executed by a processor, perform actions) and a computer-readable, non-volatile, storage medium.

In embodiments, the method according to the invention and the control device according to the invention may be carried out and implemented, respectively, for example by one or more computers, processors, application-specific integrated circuits (ASIC), digital signal processors (DSP) and/or what are known as “field-programmable gate arrays” (FPGA). In embodiments, the method according to the invention may furthermore be executed at least partially in a cloud and/or in an edge computing environment.

In practice, it is often the case that a machine or a machine type is controlled or operated by different control systems, for example different rule-based or learning-based control systems, over a relatively long operating period. The operating data that arise in this case may then be used in accumulated form to provide the largest possible set of training data for training control agents. Insofar as the training data are based on different control systems, a state space of the machine is often better covered by such training data. However, differences in the control methods carried out by the control systems often result in training of a control agent being impaired by virtue of the fact that the training data contain different control actions for the same machine state or for similar machine states. Deterministic control agents, in particular, are affected by this problem.

The above disadvantage can often be avoided or at least alleviated by embodiments of the invention insofar as a plurality of control-system-specific control agents are provided and are each specifically trained on the basis of the training data assigned to the relevant control system. Such control-system-specific control agents can generally be trained more accurately, more efficiently and/or more quickly to reproduce a control behavior of a respective control system than an individual control agent that is not specific to a control system. This also applies, in particular, to deterministic control agents.

A further advantage of embodiments of the invention is due to the fact that the performance-optimizing control agent is selected from an environment around one of the trained control-system-specific control agents. The performance-optimizing control agent to be used to control the machine therefore differs only relatively slightly from the relevant trained control-system-specific control agent in many cases. Accordingly, a control behavior of the performance-optimizing control agent often differs only slightly from a control behavior of the assigned control system. As a result, in many cases, it is possible to effectively avoid pure performance optimization from resulting in a control agent that differs too greatly from known control systems and/or operates in state ranges inadequately covered by the training data. At the same time, validation problems of stochastic control agents can be avoided by using deterministic control agents.

Embodiments and developments of the invention are specified in the dependent claims.

According to one embodiment of the invention, as a distance dimension for a distance between a first and a second control agent in the parameter space, a deviation of neural weights or other model parameters of the first control agent from those of the second control agent can be determined. Alternatively or additionally, as a distance dimension, a deviation of a control behavior of the first control agent from that of the second control agent can be determined. A respective deviation can be used to quantify a difference of the first control agent from the second control agent. A possibly weighted Euclidean distance between vector representations of the neural weights, of the model parameters or of the control behavior can be determined as a respective deviation.

The respective environment around a respective trained control-system-specific control agent can therefore be delimited as that area of the parameter space in which the model parameters or the control behavior of a control agent located therein deviate(s) only slightly from the model parameters or the control behavior of the respective trained control-system-specific control agent. In particular, the respective environment can be delimited as that area of the parameter space in which the deviation of the model parameters or of the control behavior falls below a predefined threshold value.

According to further embodiments of the invention, a population-based optimization method, a gradient-free optimization method, particle swarm optimization, a genetic optimization method and/or a gradient-based optimization method can be used to generate the test control agents and/or to carry out performance-driven optimization on the basis of the determined performance values.

The above optimization methods can be used, in particular, in the case of heterogeneous and at least partially discrete optimization problems. In addition, a multiplicity of efficient and robust numerical implementations are available for the optimization methods.

According to a further embodiment of the invention, a multiplicity of test control agents can be respectively generated and/or performance-driven optimization of test control agents can be respectively carried out in each of the environments. In this manner, a specific performance-optimizing control agent can be determined for each of the control-system-specific control agents and therefore for each of the control systems. The control agent to be used to control the machine can then be selected from the control-system-specific performance-optimizing control agents.

According to a further embodiment of the invention, in addition to a state data set and an action data set specifying a control action, a respective training data set may comprise a performance value resulting from use of this control action. Furthermore, the performance evaluator may comprise a machine learning module, in particular a transition model, which has been trained, or is trained on the basis of the training data sets, to reproduce a resulting performance value on the basis of a state data set and an action data set. The machine learning module can therefore act as a fitness evaluator for a control agent.

In particular, state data sets may be supplied to the respective test control agent and resulting output data from the test control agent can be fed, as action data sets, together with the state data sets, into the trained machine learning module. A performance value for the respective test control agent can then be determined from a resulting output value from the trained machine learning module.

The machine learning module may also have been trained or be trained to predict a resulting subsequent state of the machine on the basis of a state data set and an action data set. For a respective subsequent state, the respective test control agent can then determine a subsequent control action, the performance of which may in turn be evaluated by the machine learning module. This makes it possible to gradually extrapolate a state and a control action into the future or to predict them, with the result that a control trajectory comprising a plurality of time steps can be determined. Such an extrapolation is often also referred to as roll-out or virtual roll-out. A performance accumulated over a plurality of time steps can then be calculated for the control trajectory and assigned to the control action at the start of the trajectory. This makes it possible to also optimize the control actions with respect to longer-term performance goals. Such an accumulated performance is often also referred to as “return” in the context of reinforcement learning. In order to calculate the return, the performance values determined for future time steps may be discounted, that is to say be provided with weights that become smaller for each time step.

### BRIEF DESCRIPTION

Some of the embodiments will be described in detail, with reference to the following figures, wherein like designations denote like members, wherein:

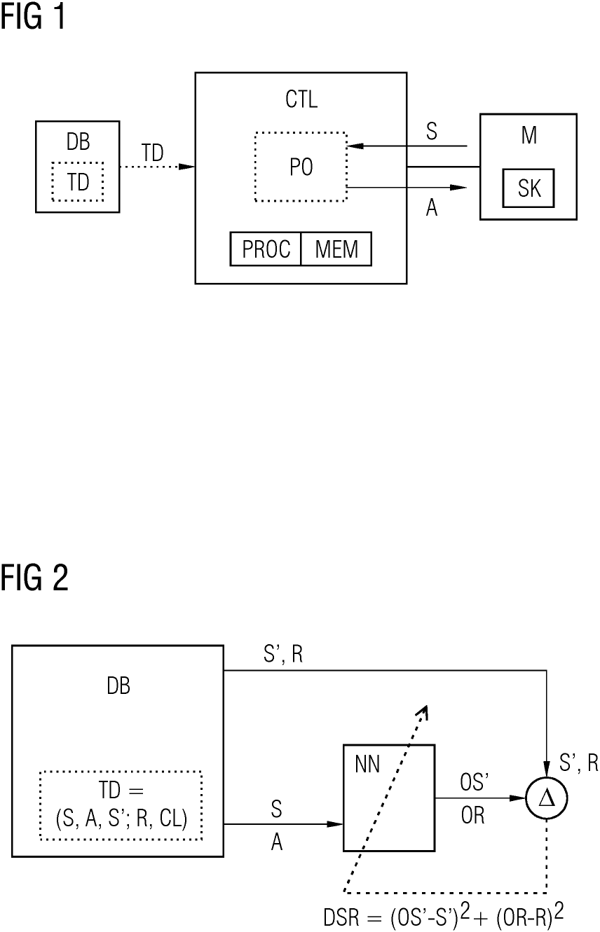

FIG. 1 shows a control device according to embodiments of the invention when controlling a machine by a control agent,

FIG. 2 shows training of a machine learning module to evaluate the performance of a control action,

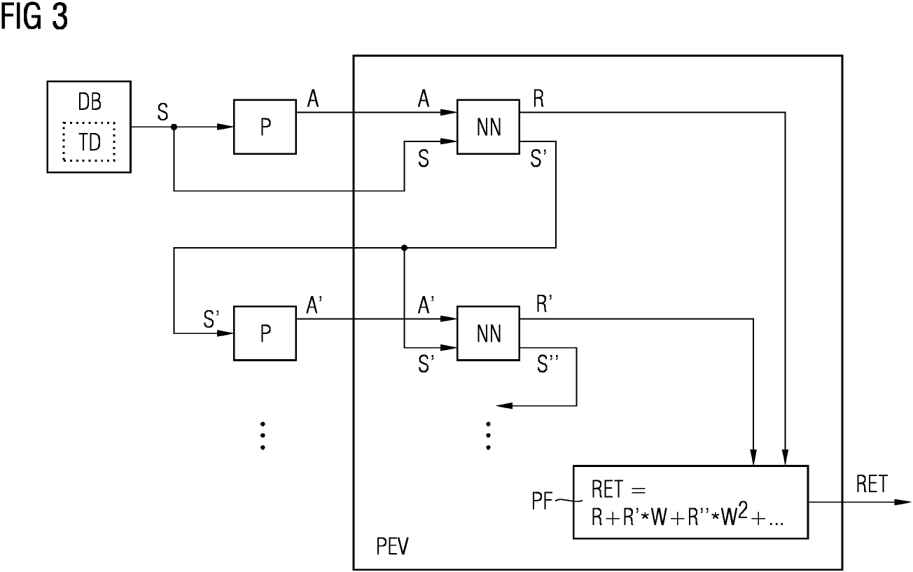

FIG. 3 shows determination of a performance of a control agent,

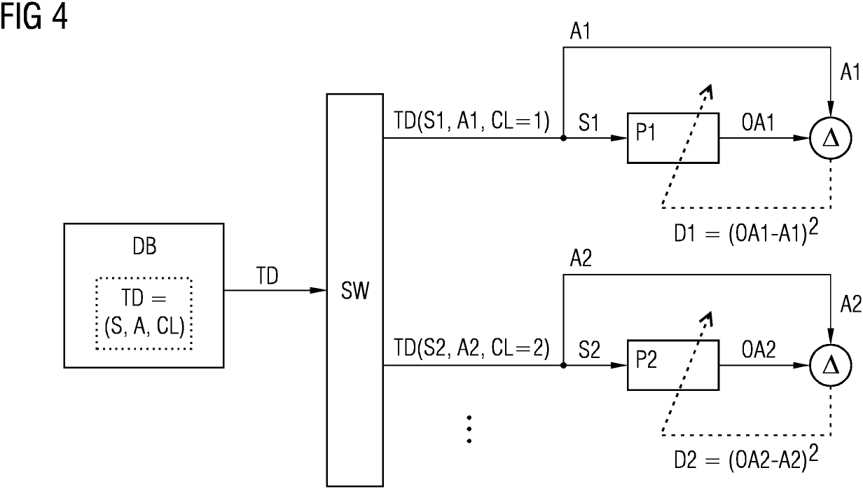

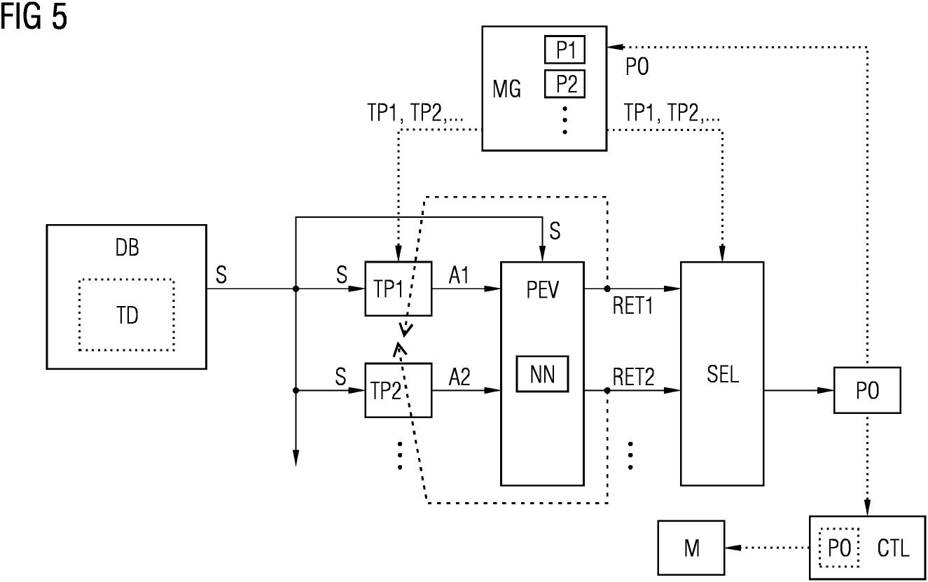

FIG. 4 shows training of control-system-specific control agents,

FIG. 5 shows determination of a performance-optimizing control agent for controlling a machine, and

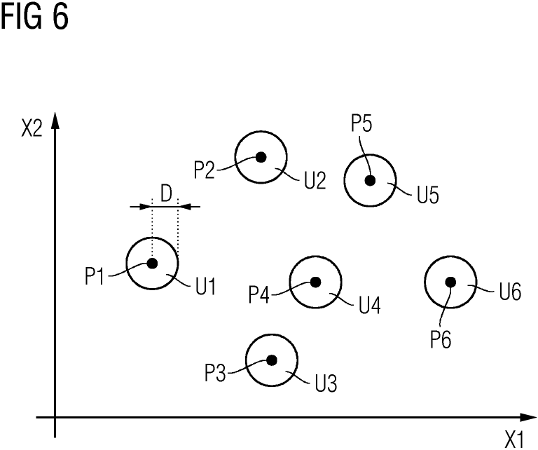

FIG. 6 shows parameter space environments of control-system-specific control agents.

### DETAILED DESCRIPTION

FIG. 1 illustrates a control device CTL according to embodiments of the invention when controlling a machine M, for example a robot, a motor, a production plant, a factory, a machine tool, a milling machine, a gas turbine, a wind turbine, a steam turbine, a chemical reactor, a cooling plant, a heating plant or another plant. In particular, a component or a subsystem of a machine may also be interpreted as a machine M.

The machine M has a sensor system SK for continuously capturing and/or measuring system states or subsystem states of the machine M.

The control device CTL is illustrated outside the machine M and is coupled to the latter in FIG. 1. Alternatively, the control device CTL may also be integrated fully or partially into the machine M.

The control device CTL has one or more processors PROC for carrying out method steps of the control device CTL and one or more memories MEM which are coupled to the processor PROC and are intended to store the data to be processed by the control device CTL.

The control device CTL also has a deterministic control agent PO for controlling the machine M. A deterministic control agent is characterized in that it outputs the same output data for the same input data. On account of its deterministic behavior, a deterministic control agent can be validated or verified more easily than a non-deterministic or stochastic control agent.

For the present exemplary embodiment, it should be assumed that the control agent PO is implemented as an artificial neural network and is trained or can be trained using reinforcement learning methods.

The control agent PO is trained and/or selected in advance in a data-driven manner on the basis of training data in order to configure the control device CTL to control the machine M in an optimized manner. The training data are taken from a database DB which stores the training data in the form of a large set of training data sets TD. The training data were recorded or measured on the machine M or a similar machine and/or generated by simulation or in a data-driven manner.

As already indicated above, such training data are generally collected over a relatively long operating period while the machine M, a similar machine and/or a simulation of the machine is/are controlled by different control systems. In this case, a respective training data set TD is assigned to that control system whose control produced the respective training data set TD.

On the basis of these training data, the control agent PO is trained and/or selected to determine a control action for a respectively predefined state of the machine M, which control action optimizes a performance of the machine M. In this case, optimization should also be understood as meaning approaching an optimum.

The performance to be optimized may relate, in particular, to a power, a yield, a speed, a runtime, a precision, an error rate, a resource consumption, an effectiveness, an efficiency, a pollutant emission, a stability, wear, a service life, a physical property, a mechanical property, an electrical property, a secondary condition to be complied with or other target variables to be optimized for the machine M or one of its components.

In addition to optimization, the trained and/or selected control agent PO can be used to control the machine M in an optimized manner. For this purpose, current operating states and/or other operating conditions of the machine M are continuously measured by the sensor system SK or determined in another manner and transmitted in the form of state data sets S from the machine M to the control device CTL. Alternatively or additionally, the state data sets S may be at least partially determined by simulation by a simulator, in particular a digital twin of the machine M.

A respective state data set S specifies a state of the machine M and is represented by a numerical state vector. The state data sets S may comprise measurement data, sensor data, environmental data or other data which arise during operation of the machine M or influence operation, in particular data relating to actuator positions, forces that occur, power, pressure, temperature, valve positions, emissions and/or resource consumption of the machine M or one of its components. In the case of production plants, the state data sets S may also relate to a product quality or other product properties.

The state data sets S transmitted to the control device CTL are fed into the trained and/or selected control agent PO as input data. On the basis of a respectively supplied state data set S, the control agent PO then generates a performance-optimizing control action in the form of an action data set A. The action data set A specifies a control action that can be performed on the machine M. In particular, the action data set A may specify manipulated variables of the machine M, for example for performing a movement trajectory in the case of a robot or for setting a gas supply in the case of a gas turbine.

The generated action data sets A are finally transmitted from the control device CTL to the machine M and are executed by the latter. In this manner, the machine M is controlled in a manner optimized for the current operating state.

FIG. 2 illustrates training of a machine learning module NN to evaluate the performance of a control action for controlling the machine M. The machine learning module NN can be trained in a data-driven manner and is intended to model a state transition when applying a control action to a predefined state of the machine M. Such a machine learning module is often also referred to as a transition model or a dynamic system model.

The machine learning module NN may be implemented in the control device CTL or completely or partially outside the latter. In the present exemplary embodiment, the machine learning module NN is implemented as an artificial neural network, in particular a neural feedforward network.

The machine learning module NN is intended to be trained, on the basis of the training data contained in the database DB, to predict, on the basis of a respective state of the machine M and a respective control action, a subsequent state of the machine M resulting from use of the control action and a resulting performance value for the machine M as accurately as possible.

The machine learning module NN is trained on the basis of the training data sets TD stored in the database DB. In this case, a respective training data set TD comprises a state data set S, an action data set A, a subsequent state data set S′ and a performance value R. As already mentioned above, the state data sets S each specify a state of the machine M and the action data sets A each specify a control action that can be performed on the machine M. Accordingly, a respective subsequent state data set S′ specifies a subsequent state resulting from application of the respective control action to the respective state, that is to say a system state of the machine M that is assumed in a subsequent time step. Furthermore, the respectively associated performance value R quantifies the respective performance of carrying out the respective control action in the respective state.

In addition, a respective training data set TD also contains a control system identifier CL that is used to assign the respective training data set TD to that control system whose control produced the respective training data set TD. In the present exemplary embodiment, however, the control system identifier CL is not taken into account when training the machine learning module NN.

As already indicated above, the performance value R may relate, in particular, to a power, a yield, a speed, a runtime, a precision, an error rate, a resource consumption, an effectiveness, an efficiency, a pollutant emission, a stability, wear, a service life, a physical property, a mechanical property, an electrical property, a secondary condition to be complied with and/or other operating parameters of the machine M which result from performance of the control action. In the context of machine learning, such a performance value is also denoted using the terms reward or -complementary to this - costs or loss.

In order to train the machine learning module NN, state data sets S and action data sets A are supplied to the module as input data. The machine learning module NN is intended to be trained such that its output data reproduce a respectively resulting subsequent state and a respectively resulting performance value as accurately as possible. The training is carried out using a supervised machine learning method.

Training should generally be understood as meaning optimizing a mapping of input data, here S and A, of a machine learning module to its output data. This mapping is optimized according to predefined criteria which have been learned and/or are to be learned during a training phase. Criteria which may be used are, in particular, a prediction error in the case of prediction models and success of a control action in the case of control models. The training may for example be used to set or optimize network structures of neurons of a neural network and/or weights of connections between the neurons such that the predefined criteria are met as well as possible. The training may thus be understood as an optimization problem. Many efficient optimization methods are available for such optimization problems in the field of machine learning, in particular gradient-based optimization methods, gradient-free optimization methods, backpropagation methods, particle swarm optimizations, genetic optimization methods and/or population-based optimization methods.

It is thus possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models or decision trees. Accordingly, the machine learning module NN may also be implemented by one or more of the machine learning models cited above or may comprise one or more machine learning models of this type.

In the present exemplary embodiment - as already mentioned above - state data sets S and action data sets A from the training data are supplied as input data to the machine learning module NN. For a respective pair (S, A) of input data sets, the machine learning module NN outputs an output data set OS’ as a predicted subsequent state data set and an output data set OR as a predicted performance value. The training of the machine learning module NN strives to achieve the situation in which the output data sets OS’ containing the actual subsequent state data sets S′ and the output data sets OR containing the actual performance values R correspond as well as possible.

For this purpose, a deviation DSR between the output data sets (OS’, OR) and the corresponding data sets (S′, R) contained in the training data is determined. In this case, the deviation DSR may be interpreted as a reproduction error or prediction error of the machine learning module NN. The reproduction error DSR may be determined, in particular, by calculating a Euclidean distance between the respective representing vectors, for example according to DSR = (OS′ - S′)² + (OR -R)².

As indicated in FIG. 2 by a dashed arrow, the reproduction error DSR is returned to the machine learning module NN. On the basis of the reproduction error DSR that is returned, the machine learning module NN is trained to minimize the reproduction error DSR, at least on average. A multiplicity of efficient optimization methods are available for minimizing the reproduction error DSR. Minimizing the reproduction error DSR means that the machine learning module NN is trained to predict a resulting subsequent state and a resulting performance value as well as possible for a predefined state and a predefined control action.

FIG. 3 illustrates determination of a performance of a control agent P by a performance evaluator PEV. The performance evaluator PEV comprises the machine learning module NN which is trained as described above.

In order to illustrate successive processing steps, FIG. 3 schematically illustrates a plurality of instances of the trained machine learning module NN and of the control agent P to be evaluated.

The various instances may correspond, in particular, to different calls or evaluations of routines, by which the machine learning module NN and the control agent P are implemented.

In order to determine the performance of the control agent P, state data sets S from the training data TD are fed into the control agent P as input data, the control agent using the input data to derive output data A which can be interpreted as action data sets. For a respective pair (S, A) of a respective state data set S and a respective action data set A, the performance evaluator PEV uses the trained machine learning module NN to predict an overall performance RET which quantifies a performance of the machine M which results from use of the respective control action A and is accumulated over a plurality of time steps into the future. In the technical field of machine learning, in particular reinforcement learning, such an overall performance is often also referred to as “return”.

In order to determine the overall performance RET, the respective action data set A is fed, together with the respective state data set S, into the trained machine learning module NN which predicts a subsequent state therefrom and outputs a subsequent state data set S′ specifying this subsequent state and an associated performance value R. The subsequent state data set S′ is in turn fed into a further instance of the control agent P which derives an action data set A′ for the subsequent state therefrom. The action data set A′ is fed, together with the respective subsequent state data set S′, into a further instance of the machine learning module NN which predicts a further subsequent state therefrom and outputs a subsequent state data set S″ specifying this further subsequent state and an associated performance value R′.

The above method steps can be repeated iteratively, wherein performance values for further subsequent states are determined. The iteration may be terminated when there is an abort condition, for example when a predefined number of iterations is exceeded. This makes it possible to determine a control trajectory, which comprises a plurality of time steps and progresses from subsequent state to subsequent state, with associated performance values R, R′, R″, ....

The determined performance values R, R′, R″, ... are supplied to a performance function PF.

The performance function PF determines, for a respective control trajectory, the overall performance RET accumulated over the control trajectory. The determined overall performance RET is then assigned to the control action, here A, at the start of the control trajectory. The overall performance RET therefore evaluates an ability of the control agent P to determine a favorable, performance-optimizing control action, here A, for a respective state data set S. The overall performance RET is calculated by the performance function PF as a performance discounted over the future time steps of a control trajectory.

For this purpose, the performance function PF calculates a weighted sum of the performance values R, R′, R″, ..., the weights of which are multiplied by a discounting factor W < 1 with each time step into the future. This makes it possible to calculate the overall performance RET according to RET = R + R′ * W + R″ * W² + ... A value of 0.99 or 0.9, for example, can be used for the discounting factor W.

The predicted overall performance RET is finally output by the performance evaluator PEV as an evaluation result for the control agent P.

FIG. 4 illustrates training of control-system-specific control agents P1, P2, ... on the basis of the training data sets TD. The control agents P1, P2, ... to be trained are deterministic control agents.

As already mentioned above, the training data sets TD were obtained by controlling the machine M, a similar machine or a simulation of the machine M by different control systems. In this case, a respective training data set TD is assigned to the respectively relevant control system by the control system identifier CL contained in the respective training data set TD. Accordingly, the state data set S and action data set A contained in the respective training data set TD are likewise assigned to the respective control system by the control system identifier CL.

In FIG. 4, the state data sets assigned to the control system with CL=1 are denoted S1 and the associated action data sets are denoted A1. Accordingly, the state data sets assigned to the control system with CL=2 are denoted S2 and the associated action data sets are denoted A2. The subsequent state data sets and performance values additionally contained in the training data sets TD are not shown in FIG. 4 for reasons of clarity.

It should be noted that the different control systems need not be explicitly known for the training of the control agents P1, P2, .... Rather, it suffices for the training data sets TD coming from different control systems to be able to be distinguished from one another.

In this manner, for each of the distinguishable control systems, a control agent P1 and P2, ... is intended to be individually trained on the basis of the training data sets TD assigned to the respective control system. A control-system-specific control agent P1 and P2, ... is therefore assigned to each of the control systems. Such control-system-specific control agents can generally be trained more accurately, more efficiently and/or more quickly to reproduce a control behavior of a respective control system than an individual control agent that is not specific to a control system.

In the present exemplary embodiment, the control agents P1, P2, ... are implemented as artificial neural networks, in particular as so-called feedforward networks.

The control agents P1, P2, ... are intended to be trained, on the basis of the training data in a control-system-specific manner, to predict an associated control action of the respectively assigned control system on the basis of a respective state of the machine M.

For this purpose, the training data sets TD from the database DB are transmitted to a distributor SW. The distributor SW serves the purpose of dividing the training data sets TD into control-system-specific training data sets TD(S1, A1, CL=1), TD(S2, A2, CL=2), ... on the basis of the included control system identifiers CL. Accordingly, the distributor SW forwards the training data sets TD(S1, A1, CL=1) with the control system identifier CL=1 for the purpose of training the control agent P1 and forwards the training data sets TD(S2, A2, CL=2) with the control system identifier CL=2 for the purpose of training the control agent P2. Similarly, further control-system-specific training data sets can be forwarded for the purpose of training further control-system-specific control agents.

In order to train the control agent P1 in a manner specific to a control system, the state data sets S1 contained in the training data sets TD(S1, A1, CL=1) are supplied as input data to the control agent. The control agent P1 derives output data OA1 from the input data S1. The control agent P1 is intended to be trained such that the output data OA1 derived from a respective state data set S1 reproduce the respective action data set A1 contained in the same training data set TD as accurately as possible, at least on average. For this purpose, a deviation D1 between the output data sets OA1 and the corresponding action data sets A1 is determined. The deviation D1 can be interpreted as a reproduction error of the control agent P1. The reproduction error D1 may be determined, in particular, by calculating a Euclidean distance between the respective representing vectors, for example according to D1 = (OA1 - A1)².

As indicated in FIG. 4 by a dashed arrow, the reproduction error D1 is returned to the control agent P1. On the basis of the reproduction error D1 that is returned, the control agent P1 is trained to minimize this reproduction error D1, at least on average. The same optimization methods as in the case of the first machine learning module NN can be used here.

Minimizing the reproduction error D1 means that the control agent P1 is trained to output a control action for a predefined state, which control action reproduces a control behavior of the assigned control system.

In an exactly corresponding manner, the control-system-specific control agent P2 can be trained on the basis of the control-system-specific training data sets TD(S2, A2, CL=2). Similarly, further control-system-specific control agents can be trained on the basis of further control-system-specific training data sets.

FIG. 5 illustrates determination of a performance-optimizing control agent PO for controlling the machine M. For this purpose, the machine learning module NN of the performance evaluator PEV and the control-system-specific control agents P1, P2, ... are first of all trained as described above.

On the basis of the trained control-system-specific control agents P1, P2, ..., a model generator MG generates a multiplicity of deterministic test control agents TP1, TP2, ... which each deviate only slightly from one of the trained control-system-specific control agents P1, P2, ....

The test control agents TP1, TP2, ... are implemented as artificial neural networks. As such, the test control agents TP1, TP2, ... are specified by a linking structure of their neurons and by weights of connections between the neurons. A respective test control agent TP1 and TP2, ... can therefore be generated by the model generator MG by generating and outputting a set of neural weights and/or a data set indicating neuron linking. For the present exemplary embodiment, it should be assumed that the model generator MG generates the different deterministic test control agents TP1, TP2, ... in the form of different sets of neural weights.

In order to generate test control agents TP1, TP2, ... which deviate only slightly from the trained control-system-specific control agents P1, P2, ..., a respective environment is delimited for a respective trained control-system-specific control agent P1 and P2, ... in a parameter space of the control agents. The parameter space may be, in particular, a vector space of neural weights or a vector space of other model parameters of the control agents.

FIG. 6 illustrates different parameter space environments U1, ..., U6 of different control-system-specific control agents P1, ..., P6. The parameter space is generally a high-dimensional vector space, two parameters X1 and X2 of which are representatively illustrated in FIG. 6.

In the present exemplary embodiment, the environment U1 is delimited as that area of the parameter space in which a deviation of a parameter vector (X1, X2, ...) from a parameter vector of the control-system-specific control agent P1 falls below a predefined threshold value D. Accordingly, a respective environment U2, ... and U6 is defined as that area in the parameter space in which a deviation of a parameter vector (X1, X2, ...) from a parameter vector of the control-system-specific control agent P2, ... and P6 falls below the threshold value D.

In the present exemplary embodiment, the model generator MG generates a multiplicity of test control agents within each of the environments U1, U2, .... The test control agents TP1, TP2, ... generated overall are therefore each within a predefinable distance D from at least one of the trained control-system-specific control agents P1, P2, ... and therefore generally have a similar control behavior. This makes it possible to effectively exclude test control agents which would output impermissible or highly disadvantageous control actions. In addition, the distance D may be varied in order to thus set a permissible deviation from known and possibly validated control agents.

As also illustrated in FIG. 5, state data sets S from the database DB are respectively supplied as input data to the generated test control agents TP1, TP2, .... For a respective state data set S, the test control agent TP1 outputs a respective action data set A1 and the test control agent TP2 outputs a respective action data set A2. The further generated test control agents similarly output further action data sets.

A respective action data set A1 from the test control agent TP1 is fed into the performance evaluator PEV which predicts an overall performance value RET1 for this action data set A1, as described above. Similarly, the performance evaluator PEV respectively determines an associated overall performance value RET2 for a respective action data set A2. Action data sets from further generated tests control agents are similarly processed.

The predicted overall performance values RET1, RET2... are fed into a selection module SEL by the performance evaluator PEV. The selection module SEL serves the purpose of selecting one or more performance-optimizing control agents PO from the generated test control agents TP1, TP2, ....

For this purpose, the test control agents TP1, TP2, ... are supplied to the selection module SEL by the model generator MG. From these test control agents, the selection module SEL selects that or those test control agent(s) which has/have the greatest overall performance values, at least on average. In the present exemplary embodiment, at least one performance-optimizing control agent PO is selected and output by the selection module SEL in this manner.

The at least one performance-optimizing control agent PO may be in turn fed into the model generator MG by the selection module SEL. In this manner, the further generation of test control agents by the model generator MG can be driven in the direction of the at least one performance-optimizing control agent PO in line with a genetic, population-based, particle-swarm-based or another gradient-free optimization method or by a gradient-based optimization method.

In addition to selecting the test control agents TP1, TP2, ..., they may also be trained, on the basis of the training data sets TD, to determine a performance-optimizing control action in the form of an action data set for a respective state data set S which has been fed in. For this purpose - as indicated by dashed arrows in FIG. 5 - the overall performance values RET1 can be returned to the test control agent TP1 and the overall performance values RET2 can be returned to the test control agent TP2. The same applies to further generated test control agents.

The model parameters of a respective test control agent TP1 and TP2, ... can then be respectively set in such a manner that the respective overall performance values are maximized, at least on average, provided that the respective test control agent TP1 and TP2, ... remains within its parameter space environment U1 and U2, .... As a result of the training described above, the performance of the at least one performance-optimizing control agent PO can be improved further in many cases. In order to specifically carry out the training, it is possible to resort to a multiplicity of efficient standard methods.

The at least one performance-optimizing control agent PO selected by the selection module SEL can finally be used to control the machine M, as explained in connection with FIG. 1. Insofar as the at least one performance-optimizing control agent PO is a deterministic control agent, the machine M is controlled deterministically, which considerably simplifies validation of the control in comparison with stochastic control. If a plurality of performance-optimizing control agents PO are selected, a control agent PO with the best performance can be selected therefrom. The latter can then be transmitted to the control device CTL in order to configure the latter to control the machine M.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a machine by a control agent, the method comprising:
a) controlling the machine using different control systems to obtain training data sets which are assigned to a respective control system and are read in, the training data sets each comprising a state data set specifying a state of the machine and an action data set specifying a control action;
b) determining, by a performance evaluator, for a control agent, a performance for controlling the machine by this control agent;
c) training a control-system-specific control agent for the different control systems on a basis of the training data sets assigned to the respective control system, to reproduce an action data set on the basis of a state data set;
d) delimiting a respective environment around the trained control-system-specific control agents on a basis of a distance dimension in a parameter space of the control-system-specific control agents;
e) generating a multiplicity of test control agents, for each of which a performance value is determined by the performance evaluator, within the environments;
f) depending on the determined performance values, selecting a performance-optimizing control agent from the test control agents; and
g) controlling the machine by the performance-optimizing control agent.

2. The method as claimed in claim 1, wherein as a distance dimension for a distance between a first control agent and a second control agent in the parameter space:
a deviation of neural weights or other model parameters of the first control agent from those of the second control agent; and/or
a deviation of a control behavior of the first control agent from that of the second control agent is/are determined.

3. The method as claimed in claim 1, wherein
a population-based optimization method, a gradient-free optimization method, particle swarm optimization, a genetic optimization method and/or a gradient-based optimization method is/are used to generate the test control agents and/or to carry out performance-driven optimization on the basis of the determined performance values.

4. The method as claimed in claim 1, wherein
in each of the environments in each case:
a multiplicity of test control agents are generated and/or
performance-driven optimization of test control agents is carried out.

5. The method as claimed in claim 1 wherein, in addition to the state data set and the action data set specifying a control action, a respective training data set comprises a performance value resulting from use of this control action, and
in that the performance evaluator comprises a machine learning module which has been trained, or is trained on the basis of the training data sets, to reproduce a resulting performance value on the basis of the state data set and the action data set.

6. The method as claimed in claim 5, wherein state data sets are supplied to the respective test control agent and resulting output data from the respective test control agent are fed, as action data sets, together with the state data sets, into the trained machine learning module, and
in that the performance value for the respective test control agent is determined from a resulting output value from the trained machine learning module.

7. The method as claimed in claim 1, wherein the control agents and/or the performance evaluator comprise(s) an artificial neural network, a recurrent neural network, a convolutional neural network, a multilayer perceptron, a Bayesian neural network, an autoencoder, a variational autoencoder, a Gaussian process, a deep learning architecture, a support vector machine, a data-driven trainable regression model, a k-nearest neighbor classifier, a physical model and/or a decision tree.

8. The method as claimed in claim 1, wherein the machine is a robot, a motor, a production plant, a factory, a machine tool, a milling machine, a gas turbine, a wind turbine, a steam turbine, a chemical reactor, a cooling plant or a heating plant.

9. A control device for controlling a machine, according to the method as claimed in claim 1.

10. A computer program product, comprising a computer readable hardware storage device having computer readable program code stored therein, said program code executable by a processor of a computer system to implement a method as claimed in claim 1.

11. A computer-readable storage medium comprising a computer program product as claimed in claim 10.
